(19) United States
(12) Patent Application Publication
(10) Pub. No.: US 2007/0030158 A1
(43) Pub. Date: Feb. 8, 2007

(54) Audible power loss alarm

(76) Inventor: Linda Leighton, Oxford, MI (US)

Correspondence Address: Galasso & Associates, LP, P. O. Box 26503, Austin, TX, 78755-0503, US

(21) Appl. No.: 11/197,079

(22) Filed: Aug. 4, 2005

(51) Int. Cl. G08B 21/00

(52) U.S. Cl. 340/663

(57) ABSTRACT

An audible power-loss alarm indicates when electrical power has been cut off to an appliance. The external components comprise a plastic housing, an alarm speaker, a battery compartment, a charging indicator light, plug-in outlets, plug-in blades, and an on-off switch. The internal components comprise a sound-producing unit, batteries, unit-activation equipment, and electrical components. The audible power-loss alarm is plugged into an electrical outlet such as a wall socket, and the appliance is plugged into the audible power-loss alarm. Wiring in the audible power-loss alarm relays AC electrical power from the electrical outlet. When a loss of power from the electrical outlet occurs, the unit-activation equipment in the audible power-loss alarm draws upon the DC power from the batteries to activate the audible alarm. To make the battery power source more reliable, rechargeable batteries may be used. To stop the alarm, the user turns off the on-off switch.

### FIELD OF THE DISCLOSURE

The present invention relates to alarms and more particularly to an audible power loss alarm for appliances.

### BACKGROUND

Millions of people have become dependent upon having a reliable source of electricity to power their appliances and other electronic equipment. Heating and cooling systems in homes and offices provide for a healthy, climate-controlled environment for people around the world. Communication systems as well as light fixtures are powered by electrical systems too. Food and beverages are kept fresh and usable by storage in refrigerators and freezers in homes and stores, helping to keep a society healthy and more independent. A loss of electrical power to these appliances for any length of time can be frustrating as well as potentially dangerous. People who have sleep apnea, for example, may rely on a breathing apparatus at night and need to be alerted to any loss of power to that apparatus that may jeopardize their health.

Prior techniques exist for alerting user to the loss of power to appliances through visible alarm signals. For example, devices are used to turn on emergency lights when power is lost to ordinary sources of lighting. These devices may operate by automatically switching from AC power to battery-supplied DC power, when the AC power to the lighting is disrupted. Although these techniques are effective in many circumstances, they have limited effectiveness for users who cannot see them. For example, users who are sleeping or have sight limitations often cannot learn quickly of losses of power to appliances from visible alarm signals. These users would benefit greatly from audible alarm signals.

The use of audible alarms for loss of power is also known in the art. For example, U.S. Pat. No. 4,808,971 for Graham provides a complicated system of modular cassette tape players for providing “individualized verbal message signals in response to the presence of a sensed digital signal in a state indicative of an abnormal process condition” for equipment. However, prior audible techniques do not provide a simple, inexpensive, and effective audible means of alerting users to the loss of power to appliances that users can employ in almost any location.

Therefore, there is a need for a simple, inexpensive, and effective audible means of alerting users to the loss of power to appliances.

### SUMMARY OF THE DISCLOSURE

The following explanation describes the present invention by way of example and not by way of limitation.

It is an aspect of the present invention to provide a simple, inexpensive, and effective audible means of alerting users to the loss of power to appliances.

It is another aspect of the present invention to provide an audible means of alerting users to the loss of power to appliances that employs battery power.

It is still another aspect of the present invention to provide an audible means of alerting users to the loss of power to appliances that employs rechargeable battery power.

These and other aspects of the present invention will become readily apparent upon further review of the following specification and associated drawings. In accordance with the present invention, an audible power-loss alarm indicates when electrical power has been cut off to an appliance. The external components comprise a plastic housing, an alarm speaker, a battery compartment, a charging indicator light, plug-in outlets, plug-in blades, and an on-off switch. The internal components comprise a sound-producing unit, batteries, unit-activation equipment, and electrical components. The audible power-loss alarm is plugged into an electrical outlet such as a wall socket, and the appliance is plugged into the audible power-loss alarm. Wiring in the audible power-loss alarm relays AC electrical power from the electrical outlet. When a loss of power from the electrical outlet occurs, the unit-activation equipment in the audible power-loss alarm draws upon the DC power from the batteries to activate the audible alarm. To make the battery power source more reliable, rechargeable batteries may be used. To stop the alarm, the user turns off the on-off switch.

### BRIEF DESCRIPTION OF THE DRAWINGS

The following embodiments of the present invention are described by way of example only, with reference to the accompanying drawings, in which:

FIG. 1 is a block diagram that illustrates an audible power-loss alarm for appliances.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention comprises an audible alarm that indicates when electrical power has been cut to an appliance. For example, it could serve to alert a homeowner to the fact that the electrical current has been stopped to an appliance such as a refrigerator or freezer because of a power outage. It could also server to alert office workers to losses of power to business machines. It makes use of technology that is commonly used in the production of standard alarm systems where motion or contact is at the center of its activation process.

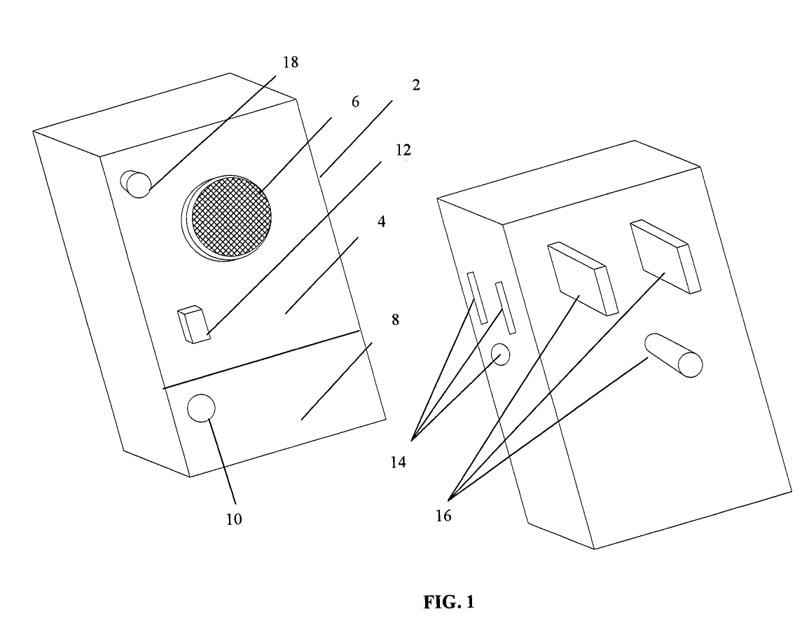

As shown in FIG. 1, the audible power-loss alarm 2 comprises the following externally visible elements:
A plastic housing 4,
An alarm speaker 6,
A battery compartment 8,
A charging light indicator 10,
An on-off switch 12,
Plug-in outlets 14,
Plug-in blades 16, and
A volume control 18.

The internal components, well known to those skilled in the art, comprise
A sound-producing unit,
Batteries.
Unit-activation equipment, and
Electrical components.

The housing 4 serves to contain and protect the components of the audible power-loss alarm 2 and should be manufactured of a hard, durable plastic such as polyethylene, polypropylene or other similar thermoplastic material.

The alarm speaker 6 amplifies the sound produced upon activation by the sound-producing unit, so that the user may hear the alarm.

In another embodiment, the alarm speaker 6 and sound producing unit may be located remotely from the appliance and connected to it by wiring. For example, an audible power-loss alarm for a kitchen refrigerator could have an alarm speaker and sound producing unit in a bedroom or living room to alert users there. Other forms of connection permit the location of an alarm speaker and sound producing unit across town from an appliance, for example to notify office workers to losses of power to home appliances.

In still another embodiment, an alarm speaker and sound producing unit may be located on another device so that that device may be located in the dark during a power outage. For example, the alarm speaker may be located on a fuse box, so that the fuse box may found easily.

The battery compartment 8 has a plastic door that opens to expose an area where batteries may be attached, well known to those skilled in the art. In an embodiment, the battery compartment 8 accommodates rechargeable batteries.

The charging light indicator 10, also known to those skilled in the art, turns red to show that rechargeable batteries are charging and turns green to show that they are fully charged.

A user may employ the on-off switch 12 to turn the audible power-loss alarm 2 on and off. For example, if the alarm sounds to indicate a power loss, the user may use the power-loss alarm 2 to turn the alarm off, and can turn the audible power-loss alarm 2 back on after power is restored.

The plug-in outlets 14, shown on the side of the audible power-loss alarm 2 in a rear view in FIG. 1, enable an appliance to be plugged into the audible power-loss alarm 2. In an embodiment, the audible power-loss alarm 2 may comprise multiple sets of plug-in outlets 14, so that multiple appliances may be attached.

The plug-in blades 16 enable the audible power-loss alarm 2 to be plugged into an electrical power source, such as a wall socket. In an embodiment, multiple sets of plug-in blades 16 may be used for providing power to multiple appliances, in conjunction with the multiple sets of plug-in outlets 14 explained above.

In an embodiment, the audible power-loss alarm 2 may further comprise a volume control 18 that the user can employ to increase or decrease the volume of the audible alarm.

Internally, the audible power-loss alarm 2 comprises components known to those skilled in the art. When a loss of power occurs, unit-activation equipment, like that employed for hospital emergency lighting systems, uses DC electrical power from the batteries stored in the battery compartment 8 to activate a sound-producing unit. The sound-producing unit produces an alarm sound, for example a buzzer sound, which is amplified by the alarm speaker 6, to alert the user to the loss of power. Many types of commonly available batteries may be employed in different embodiments, for example AA batteries. In an embodiment the batteries are rechargeable batteries that are recharged by the source of AC power, so that the batteries are always charged or being re-charged.

The electrical components comprise wiring that joins the audible power-loss alarm 2 and the appliance to which it would be connected. They enable AC electrical power from the power source to pass through the audible power-loss alarm 2 to the apparatus.

Use

In a typical scenario, a user places appropriate batteries in the battery compartment 8 of the audible power-loss alarm 2. The user then plugs the plug-in blades 16 on the audible power-loss alarm 2 into a power source, such as a wall socket, and turns on the on-off switch 12. In an embodiment using rechargeable batteries, the charging light indicator 10 turns red to show when rechargeable batteries are charging and turns green to show that they are fully charged. The user then plugs the power cord of an appliance, for example a refrigerator, into a set of plug-in outlets 14 on the audible power-loss alarm 2, providing AC electrical power to the appliance. In an embodiment, the user can further adjust the volume control 18 to a desired alarm volume level sufficient to attract that person's attention. Rechargeable batteries are used so that the batteries are always charged or are being re-charged by the AC power source.

Subsequently a loss of power from the power source will trigger the unit-activation equipment in the audible power-loss alarm 2 to use DC power from the batteries to activate the sound-producing unit to produce a sound. The sound is amplified by the alarm speaker 6 so that the user can hear the alarm. The user will then be alerted to the loss of power, can use the on-off switch 12 to turn off the audible alarm, and can take appropriate steps to deal with the loss of power.

In another embodiment, the audible power-loss alarm 2 may be connected to a power source independently of any appliance. In this case the audible power-loss alarm can indicate a general loss of power.

In other embodiments, the alarm speaker and sound producing unit associated with the audible power-loss alarm 2 may be connected to the appliance remotely, for example in another room.

All the electronic components of the audible power-loss alarm should meet or exceed all safety usage regulations and generally accepted electrical codes. Wiring and associated connecting hardware along with any auditory transmission devices should be insulated and otherwise protected from intrusion by any harmful or degrading elements including water, medium level temperatures, and low to medium impact force.

The best dimensional relationships for the parts of the invention described above, including variations in form and use, will be readily apparent to those skilled in the art, and are intended to be encompassed by the present invention. For example, the present invention may vary in size and shape as it is manufactured for different pieces of electrical equipment.

What is claimed is:

1. An audible power-loss alarm, the audible power-loss alarm comprising
a housing,
an alarm speaker, such that the alarm speaker amplifies a sound produced by a sound-producing unit,
a battery compartment, such that the battery compartment can contain at least one battery,
an on-off switch, such that moving the on-off switch turns the audible power-loss alarm on and off,
at least one set of electrical plug-in outlets, such that plug-in blades from at least one electrical appliance may be plugged into the plug-in outlets, at least one set of electrical plug-in blades, such that the plug-in blades may be plugged into at least one electrical power source,
a sound-producing unit,
at least one battery, and
unit-activation equipment, such that the unit-activation equipment uses DC electrical power from the batteries to activate the sound-producing unit in the case of a loss of electrical power to the audible power-loss alarm, and
electrical components, such that the electrical components enable AC electrical power from the power source to pass through the audible power-loss alarm to at least one appliance that is plugged into the audible power-loss alarm.

2. The housing of claim 1, wherein the housing comprises
a charging light indicator for rechargeable batteries;

3. The charging light indicator for rechargeable batteries of claim 2, wherein the charging light indicator for rechargeable batteries
turns red to show that rechargeable batteries are charging, and
turns green to show that rechargeable batteries are fully charged.

4. The housing of claim 1, wherein the housing comprises a volume control, such that the volume control controls the volume of the sound-producing unit.

5. The alarm speaker of claim 1, wherein the alarm speaker is located on the audible power-loss alarm.

6. The alarm speaker of claim 1, wherein the alarm speaker is located remotely from the audible power-loss alarm.

7. The sound producing unit of claim 1, wherein the alarm speaker is located on the audible power-loss alarm.

8. The sound producing unit of claim 1, wherein the alarm speaker is located remotely from the audible power-loss alarm.

9. The batteries of claim 1, wherein the batteries are rechargeable batteries.

10. An audible power-loss alarm, the audible power-loss alarm comprising
a housing,
an alarm speaker located on the audible power-loss alarm, such that the alarm speaker amplifies a sound produced by a sound-producing unit,
a battery compartment, such that the battery compartment can contain at least one rechargeable battery,
a charging light indicator for at least one rechargeable battery, such that the charging light indicator for at least one rechargeable battery
turns red to show that at least one rechargeable battery is charging, and
turns green to show that at least one rechargeable battery is fully charged;
an on-off switch, such that moving the on-off switch turns the audible power-loss alarm on and off,
at least one set of electrical plug-in outlets, such that plug-in blades from at least one electrical appliance may be plugged into the plug-in outlets,
at least one set of electrical plug-in blades, such that the plug-in blades may be plugged into at least one electrical power source,
a sound-producing unit speaker located on the audible power-loss alarm,
at least one rechargeable battery,
unit-activation equipment, such that the unit-activation equipment uses DC electrical power from the batteries to activate the sound-producing unit in the case of a loss of electrical power to the audible power-loss alarm, and
electrical components, such that the electrical components enable AC electrical power from the power source to pass through the audible power-loss alarm to at least one appliance that is plugged into the audible power-loss alarm, and
a volume control, such that the volume control controls the volume of the sound-producing unit.

11. An audible power-loss alarm, the audible power-loss alarm comprising
a housing,
an alarm speaker located remotely from the audible power-loss alarm, such that the alarm speaker amplifies a sound produced by a sound-producing unit,
a battery compartment, such that the battery compartment can contain at least one rechargeable battery,
a charging light indicator for at least one rechargeable battery, such that the charging light indicator for at least one rechargeable battery
turns red to show that at least one rechargeable battery is charging, and
turns green to show that at least one rechargeable battery is fully charged;
an on-off switch, such that moving the on-off switch turns the audible power-loss alarm on and off,
at least one set of electrical plug-in outlets, such that plug-in blades from at least one electrical appliance may be plugged into the plug-in outlets,
at least one set of electrical plug-in blades, such that the plug-in blades may be plugged into at least one electrical power source,
a sound-producing unit speaker located remotely from the audible power-loss alarm,
at least one rechargeable battery,
unit-activation equipment, such that the unit-activation equipment uses DC electrical power from the batteries to activate the sound-producing unit in the case of a loss of electrical power to the audible power-loss alarm, and
electrical components, such that the electrical components enable AC electrical power from the power source to pass through the audible power-loss alarm to at least one appliance that is plugged into the audible power-loss alarm, and
a volume control, such that the volume control controls the volume of the sound-producing unit.
